(19) United States
(12) Patent Application Publication
(10) Pub. No.: US 2025/0073974 A1
(43) Pub. Date: Mar. 6, 2025

(54) PROCESS AND APPARATUS FOR MAKING INSULATED PIPE

(71) Applicant: SET EHF., Selfoss (IS)

(72) Inventors: Valdimar HJALTASON, Selfoss (IS); Orn EINARSSON, Selfoss (IS)

(21) Appl. No.: 18/727,960

(22) PCT Filed: Jan. 10, 2023
(86) PCT No.: PCT/IS2023/050001

§ 371 Date: Jul. 10, 2024

(30) Foreign Application Priority Data
Jan. 10, 2022 (IS) 050354

(51) Int. Cl. B29C 48/00; B29C 48/09; B29C 48/13; B29C 48/18; B29K 105/04; B29L 23/00

(52) U.S. Cl. CPC B29C 48/0021; B29C 48/0012; B29C 48/0019; B29C 48/09; B29C 48/13; B29C 48/18; B29K 2105/04; B29L 2023/225

(57) ABSTRACT

A method and apparatus are provided for producing pre-insulated pipes, which can be configured both for producing corrugated pipes and smooth pipes. The new method does not require a film to enclose expanding foam insulation around an inner pipe prior to it being enclosed by a jacket casing. Instead, a jacket casing is extruded around the inner pipe, the inner pipe and casing fed into a vacuum unit and the inside of the jacket casing is surface treated to ensure adherence between layers just after it exits the extruder and before it is fed into a vacuum unit. Inside the vacuum unit, a dispenser dispenses liquid expanding insulation material (such as polyurethane) in the space between the jacket casing and the inner pipe.

### FIELD OF INVENTION

The invention is in the field of insulated pipes and plastics and specifically concerns a process and apparatus for producing an insulated pipe with an inner pipe, an outer jacket that may or may not be corrugated and an insulation layer therein between.

### BACKGROUND

Insulated pipes are widely used in district heating systems and in industrial settings for cooled or heated liquids or gases. Typically, such pipes comprise an inner pipe, e.g. metal or plastic pipe, from a suitable material depending on the substance to be transmitted in the pipe, insulation material and an outer jacket to provide an outer barrier and to protect the insulation material. Corrugated pipes (i.e. with an outer corrugated jacket) are advantageous in that they provide more flexible pipes that can be rolled up and thus much longer individual pipe segments can be used, limiting the number of connectors needed between pipe segments.

Early methods for manufacturing flexible pre-insulated pipes used so-called discontinuous methods, where a corrugated plastic casing or jacket is first produced, then an inner pipe is fed through the casing, followed by a step of dispensing insulation into the gap between the jacket and inner tube. This method has the disadvantage that it is difficult to dispense insulation into long segments and to ensure that the insulation fills all corrugation recesses.

EP897788 describes a method where an inner tube is surrounded by a film shaped to form a hose or circular bag, and a synthetic foam is dispensed into the spacing between the inner tube and hose. The hose with the expanding foam is fed through a corrugator that forms the hose and enclosed foam material into a corrugated shape. The corrugated hose then enters an extruder that extrudes an outer tube (jacket) on to the corrugated hose, taking the shape of the hose. The document mentions that the film should preferably be treated with corona treatment on the surface facing the foam, to create an intimate connection between the film and the foam.

Corona treatment is a surface modification technique that uses a low temperature corona discharge plasma to impart changes in the properties of a surface. The corona plasma is generated by the application of high voltage to an electrode that has a sharp tip. The plasma forms at the tip of the electrode. An array of electrodes is often used to create a curtain of corona plasma. Plastics, as well as other materials such as cloth or paper, may be passed through the corona plasma curtain in order to change the surface energy of the material. The method was invented to make it possible to print on plastics.

WO 0039497A1 discloses a process for the continuous production of pre-insulated pipes, wherein a foaming mixture is continuously brought into contact with the outer surface of an inner pipe and is allowed to expand into a polyisocyanurate-modified polyurethane foam, after which a casing is applied around this foam. A film is used to contain the foam insulation before the casing is applied around the inner pipe and foam. Bringing the foaming mixture into contact with the outer surface of an inner pipe may take place either by applying the foaming mixture directly onto the outer surface of the inner pipe or by first applying the foaming mixture onto a film positioned under the inner pipe and subsequently folding this film around said inner pipe, thereby bringing the foaming mixture into contact with the outer surface of the inner pipe.

In WO 2014/122278 an improved method is disclosed where an inner pipe is covered with a film, an expandable liquid insulation material (e.g. polyurethane) is dispensed between the inner pipe and the film, then a layer of outer casing (typically of polyethylene) is extruded onto the assembly of insulation and enclosing film before the insulation material has expanded completely, thereby creating a still expanding insulated pipe assembly and leading the still expanding insulated pipe assembly through a corrugator giving the casing a corrugated shape, with the insulation expanding into the corrugation recesses.

### SUMMARY

The present invention provides a new method and apparatus for producing pre-insulated pipes and is useful in particular for producing corrugated pipes but can as well be used for smooth pipes. The new method does not require a film to enclose expanding foam insulation prior to it being enclosed by a jacket casing. Instead, a jacket casing is extruded around an inner pipe and the inside of the jacket casing is surface treated to ensure adherence between layers just after it exits the extruder and before it is fed into a tube vacuum unit. Inside the tube vacuum unit, a dispenser dispenses liquid expanding insulation material (such as polyurethane) in the space between the jacket casing and the inner pipe.

The method is particularly useful, but not limited to, production of insulated corrugated pipes, where it is very advantageous to introduce expanding insulation into an outer extruded casing before the casing is corrugated, that is, just after the casing has been extruded and before it has cooled and hardened. This way, the soft still expanding insulation fills the jacket and if the jacket is then corrugated before the insulation has fully expanded and hardened the insulation will take the shape of the corrugated inner surface of the jacket as the insulation fully expands and sets. In order for the insulation material to adhere efficiently, it is therefore necessary to surface treat the inner jacket surface before the insulation expands to the surface and before the optional corrugation, that is, before the jacket has cooled and solidified.

Thus, in one aspect the invention sets forth a method for producing an insulated pipe that comprises an inner pipe, an outer jacket casing and insulation layer between the inner pipe and the outer jacket casing, where the method comprises at least the following steps:
feeding the inner pipe through an extruder head and further into a tube vacuum unit,
extruding by said extruder head a jacket casing around the inner pipe prior to it entering the vacuum unit,
surface-treating the inner surface of the jacket casing to enhance attachment properties of the inner surface towards insulation material,
feeding the jacket casing into said tube vacuum unit,
dispensing expandable liquid insulation material in the space between the inner pipe and the jacket casing to obtain an insulation layer, and
feeding the obtained pipe assembly comprising the inner pipe, outer jacket casing and insulation layer through said tube vacuum unit to obtain an insulated pipe.

In the method, the surface-treating step takes place upstream of the dispensing of insulation and before the extruded jacket solidifies.

The outer jacket casing is extruded and thus generally comprises an extrudable suitable plastic such as polyethylene (PE, including HDPE and LDPE, and polyethylene terephthalate, PET), polyvinyl chloride (PVC), polypropylene (PP), polybutylene (PB), acrylonitrile butadiene styrene (ABS), poly-carbonate (PC) and rubber. The inner pipe can be essentially of any suitable material such as metal or plastic, for example but not limited to the above-mentioned plastics, stainless steel, iron, aluminium or an alloy.

The insulation is of the type which is expandable liquid when dispensed, and after dispensing it expands and solidifies. Examples include polyurethane foam, polyisocyanurate foam, polyimide foam, polyisocyanate-based foams, and other thermosetting foams such as epoxy foams or phenolic foam.

The term tube vacuum unit as used herein refers to a device that receives the tube assembly into an extended tubular space conveyor (tunnel) where vacuum suction is applied, such that when an extruded jacket casing is fed into the vacuum unit it is sucked toward the walls of the tunnel. When smooth (non-corrugated) pipes are produced with the present invention, the tube vacuum unit preferably comprises a vacuum spray tank or vacuum calibration tank, also referred to as calibration sleeve.

In an advantageous embodiment, the tube vacuum unit comprises a corrugator, when the apparatus and method is used to produce a corrugated pipe. Such corrugator is as such well known in the art and typically comprises a conveyor of mould blocks such that the inner surface of the tube vacuum unit tunnel has a corrugated surface, which moulds the extruded jacket casing into the same corrugated shape. The vacuum suction aids in the moulding process.

As mentioned above, it is an advantage of the present invention that a film is not needed to enclose the expanding insulation, as the insulation is instead dispensed directly into the extruded casing. In order to ensure good attachment of the insulation to the jacket casing, this requires proper surface treatment of the inner surface of the extruded jacket casing. Advantageously, this can be achieved with the present invention with corona treatment of the soft semi-liquid casing just after it is extruded. Corona treatment of plastic surfaces such as plastic films is as such well known in the art. An array of electrodes can be used to create a curtain of corona plasma. In the present invention, preferably the corona system comprises a substantially circular array of electrodes shaped and positioned to generate a circular plasma curtain. In other embodiments other technologies are used for the surface treatment, such as flame plasma, where gas is ignited to create a flame that imparts the desired changes to the surface. A suitable formed array of nozzles is preferably used to obtain a desired shaped flame, such as a circular array of nozzles.

In some embodiments a surface treatment system based on air plasma or chemical plasma treatment is used. In air plasma the pressure of the plasma is about equal to that of the surrounding atmosphere, chemical plasma is based on the combination of air plasma and flame plasma. Much like air plasma, chemical plasma fields are generated from electrically charged air. But, instead of air, chemical plasma relies on a mixture of other gases depositing various chemical groups onto the treated surface.

As mentioned, the dispensing of the expanding insulation material takes place downstream of the surface treatment and may advantageously take place within the tube vacuum unit (or corrugator unit) or in the vicinity of the entry to the tube vacuum unit/corrugator unit. This means that the insulation is typically dispensed where the jacket layer is still soft, and in the case where corrugation is applied, the insulation is dispensed preferably close to the entry of the corrugator or just inside the corrugator, such that the insulation will not become hardened until after the jacket casing has been corrugated. In a preferred embodiment, the insulation is dispensed into the jacket layer which is then corrugated (i.e. the insulation is dispensed prior to the corrugation), in another embodiment the insulation is dispensed as the jacket casing is being corrugated or at a point just after the jacket casing becomes corrugated.

Another aspect of the invention provides an apparatus for producing an insulated pipe comprising:
an extruder head for extruding a tubular jacket casing,
a surface treatment system for surface-treating the inner surface of said jacket casing to enhance attachment properties of said inner surface towards insulation material,
a tube vacuum unit for receiving said tubular jacket layer and an inner pipe enclosed by said jacket layer,
at least one dispenser for dispensing expandable liquid insulation material, said dispenser arranged within said tube vacuum unit, and
a mixer for mixing expandable liquid insulation material, with a feed tube connected to said at least one dispenser.

It follows that the surface treatment system of the apparatus is positioned and configured to surface treat extruded tubular jacket casing upstream of the dispenser and preferably and typically the surface treatment system is positioned upstream of said vacuum unit. Most preferably the surface treatment system is positioned and arranged within said extruder.

The surface treatment system is in one embodiment a corona treatment system, which can be based on a corona discharge electrode or a plasma generating flame, as mentioned above. The system is arranged to provide the corona treatment to the inner surface of the extruded jacket casing, preferably in the vicinity of the extruder such that the inner surface is treated shortly after the casing is extruded, and in any case before the expanding insulation is dispensed within the casing, in the space between the casing and the inner tube. In some embodiments the surface treatment system comprises a corona discharge electrode positioned to provide corona discharge to the tubular jacket layer extruded from said extruder head, and a grounded electrode placed to be opposite the tubular jacket from the discharge electrode. The corona discharge electrode should preferably be shaped and configured so as to provide a substantially circular corona discharge and the said grounded electrode is arranged as a collar through which the extruded jacket layer is fed.

As described above, the tube vacuum unit can be, for example, a vacuum mould conveyor or vacuum spray chamber. In some embodiments the tube vacuum unit comprises a corrugator, as described herein above.

### BRIEF DESCRIPTION OF THE DRAWINGS

FIG. 1 shows a cross-section along the axis of an apparatus of the invention, with a tube vacuum unit for producing smooth pipes.

FIG. 2 shows a cross-section along the axis of an apparatus of the invention, with a corrugator unit for producing corrugated pipes.

### DETAILED DESCRIPTION

In the following, exemplary embodiments of the invention will be described, referring to the accompanying figure. These examples are set forth to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be between some or all of the described steps.

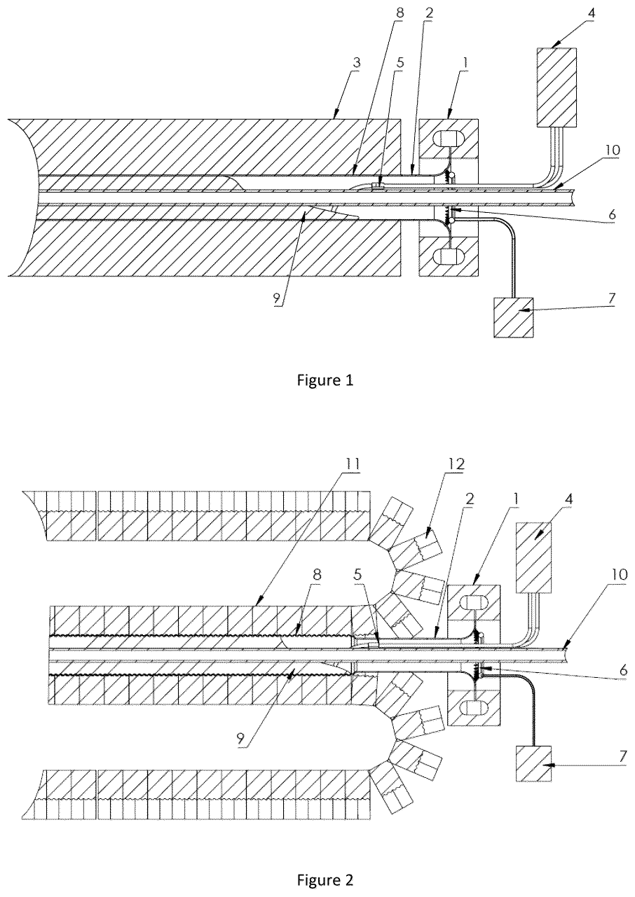

Main parts of an apparatus of the invention configured to make smooth pipes are shown in FIG. 1 that shows a cross-sectional view along the axis of the apparatus. An inner pipe 10 is fed along the axis of the apparatus. An extruder 1 extrudes the plastic jacket casing 2 which forms a jacket casing 8 around the inner pipe 10. A mixer 4 for expandable insulation feeds the components of the insulation to a dispenser 5 which is placed inside the tube vacuum unit 3 such that insulation 9 is dispensed in the space between the inner pipe 10 and jacket casing 8. A surface treatment unit is provided to apply surface treatment to the inner surface of the extruded jacket casing before it enters the vacuum unit.

The surface treatment unit is shown here as a corona plasma unit with an array of high voltage discharge electrodes 6 and a power unit 7 with a corona generator and transformer. A grounded electrode (not shown) is arranged as a collar opposite from the discharge electrodes with respect to the extruded casing. The pipe assembly is then fed through the vacuum unit and exits at an exit end (not shown) as a ready insulated pipe comprising an inner pipe, an outer jacket and an insulation layer therein between.

FIG. 2 shows a corresponding cross-sectional view for an apparatus configured for producing corrugated pipes. In this configuration the vacuum unit comprises a corrugator-conveyor 11 with moulded blocks 12 with the desired corrugated shape. Other components (extruder, dispenser for insulation material, surface treatment unit) are essentially the same as in the configuration shown in FIG. 1. Accordingly, as in the above embodiment, an inner pipe 10 is fed along the central axis of the apparatus and through the extruder 1, which extrudes a jacket casing 2 around the pipe. A corona discharge electrode assembly 6 applies surface treatment to the inner surface of the extruded casing 2 before enters the corrugator 11. A dispenser 5 is positioned just inside or in the vicinity of the vacuum tube entry for dispensing expanding insulation 9 into the space between the jacket casing 2 and inner tube 1. The pipe assembly with the still soft extruded jacket layer and the expanding insulation is then fed forward through the corrugator, which imprints a corrugated shape on the jacket layer and the expanding insulation will very effectively fill all the corrugations, not leaving voids in the hills of the corrugation.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to” and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A method for producing an insulated pipe that comprises an inner pipe, an outer jacket casing and insulation layer between the inner pipe and the outer jacket casing, the method comprising the steps of:
a) feeding the inner pipe through an extruder head and further into a tube vacuum unit,
b) extruding by said extruder head a jacket casing around the inner pipe prior to it entering the tube vacuum unit,
c) surface-treating the inner surface of said jacket casing to enhance attachment properties of said inner surface towards insulation material,
d) feeding said jacket casing into said tube vacuum unit,
e) dispensing expandable liquid insulation material in the space between the inner pipe and the jacket casing to obtain said insulation layer,
f) feeding the obtained pipe assembly comprising said inner pipe, said jacket and said insulation layer through said tube vacuum unit to obtain said insulated pipe,
wherein said step c) takes place upstream of step e) and before the extruded jacket solidifies.

2. The process according to claim 1, wherein said surface-treating comprising corona treatment of said inner surface of the jacket layer.

3. The process according to claim 2, wherein said corona treatment is provided by a corona treating system comprising a discharge electrode that is positioned and shaped so as to discharge substantially circularly towards the inner jacket surface after the jacket surface has been extruded from extrusion exit(s) of the extrusion head.

4. The process according to claim 1, wherein said tube vacuum unit comprises a corrugator and wherein step f) provides corrugation of the outer jacket layer.

5. The process according to claim 1, wherein said dispensing expandable liquid insulation material takes place inside said tube vacuum unit.

6. An apparatus for producing an insulated pipe comprising:
an extruder head for extruding a tubular jacket casing,
a surface treatment system for surface-treating the inner surface of said jacket casing to enhance attachment properties of said inner surface towards insulation material,
a tube vacuum unit for receiving said tubular jacket layer and an inner pipe enclosed by said jacket layer,
at least one dispenser for dispensing expandable liquid insulation material, said dispenser arranged within said tube vacuum unit,
a mixer for mixing expandable liquid insulation material, with a feed tube connected to said at least one dispenser,
wherein said surface treatment system is positioned and configured to surface treat extruded tubular jacket casing upstream of said dispenser.

7. The apparatus according to claim 6, wherein said surface treatment system is positioned upstream of said vacuum unit.

8. The apparatus according to claim 7, wherein said surface treatment system is positioned and arranged within said extruder.

9. The apparatus according to claim 6, wherein said surface treatment system comprises a corona treatment system.

10. The apparatus according to claim 9, wherein said corona treatment system comprises a corona discharge electrode positioned to provide corona discharge to the tubular jacket layer extruded from said extruder head, and a grounded electrode placed to be opposite the tubular jacket from the discharge electrode.

11. The apparatus according to claim 10, wherein said corona discharge electrode is shaped and configured so as to provide a substantially circular corona discharge and wherein said grounded electrode is arranged as a collar through which the extruded jacket layer is fed.

12. The apparatus according to claim 6, wherein said surface treatment system comprises a flame corona system.
